(19) United States
(12) Patent Application Publication
(10) Pub. No.: US 2008/0250779 A1
(43) Pub. Date: Oct. 16, 2008

(54) Method and Device for the Dosed Provision of a Reducing Agent, Especially a Solid Reducing Agent, for Exhaust Gas Systems

(75) Inventors: Rolf Bruck, Bergisch Gladbach (DE); Peter Hirth, Rosrath (DE); Ulf Klein, Neunkirchen-Seelscheid (DE); Wolfgang Held, Wolfsburg (DE)

Correspondence Address: LERNER GREENBERG STEMER LLP, P O BOX 2480, HOLLYWOOD, FL, 33022-2480, US

(73) Assignee: EMITEC GESELLSCHAFT FUR EMISSIONSTECHNOLOGIE MBH, Lohmar (DE)

(21) Appl. No.: 11/872,121

(22) Filed: Oct. 15, 2007

Related U.S. Application Data
(63) Continuation of application No. PCT/EP2006/003177, filed on Apr. 7, 2006.

(30) Foreign Application Priority Data
Apr. 15, 2005 (DE) DE102005017402.7

(51) Int. Cl. B01D 53/56; F01N 3/10; B01D 53/94

(52) U.S. Cl. 60/303; 422/180; 60/286; 60/299; 422/171; 422/119; 423/213.2; 700/271

(57) ABSTRACT

A device for exhaust gas treatment includes an exhaust gas line through which an exhaust gas can flow in a flow direction, a supply for feeding a reducing agent into the exhaust gas line, a regulating unit for dosing the reducing agent to be supplied, and a carrier body for bringing about a chemical reaction of the reducing agent with at least one constituent of the exhaust gas. The carrier body is positioned downstream of the supply in the flow direction, and the carrier body has at least one metallic base body at least partially including a coating with a storage capability for the reducing agent. Two methods for the dosed provision of a reducing agent, especially a solid reducing agent, are also provided. The methods and device allow economical use of the reducing agent while guaranteeing an approximately 100% reaction of the nitrogen oxides contained in the exhaust gas.

### CROSS-REFERENCE TO RELATED APPLICATIONS

This is a continuing application, under 35 U.S.C. § 120, of copending International Application No. PCT/EP2006/003177, filed Apr. 7, 2006, which designated the United States; this application also claims the priority, under 35 U.S.C. § 119, of German Patent Application No. DE 10 2005 017 402.7, filed Apr. 15, 2005; the prior applications are herewith incorporated by reference in their entirety.

### BACKGROUND OF THE INVENTION

### Field of the Invention

The present invention relates to a device for the exhaust gas treatment of an internal combustion engine and to a method for the treatment of such exhaust gas by dosed provision of a reducing agent. The device and the method are used, in particular, in the automotive field.

The composition of the exhaust gas generated by an internal combustion engine is representative of its operation or type. A problem with regard to the purification or decontamination of mobile exhaust gases is encountered in this case, in particular, by lean-burn internal combustion engines, that is to say internal combustion engines which have exhaust gas with a high oxygen proportion. The exhaust gas of those internal combustion engines contains, in addition to the usual pollutants carbon monoxide (CO), nitrogen oxides (NOₓ) and unburned hydrocarbons (HC) as well as particles (PM), a high proportion of up to 15% by volume of oxygen, so that the exhaust gas has an oxidizing effect overall. The usual exhaust gas purification methods for stoichiometrically-operated internal combustions, through the use, for example, of three-way catalytic converters, therefore cannot be applied effectively. In particular, the conversion of the nitrogen oxides to form nitrogen (N₂) in the oxidizing exhaust gas atmosphere poses considerable difficulties. The main components of the nitrogen oxides in the exhaust gas of lean-burn internal combustion engines are nitrogen monoxide (NO) and nitrogen dioxide (NO₂), with nitrogen monoxide forming the largest proportion. Depending on the operating conditions of the internal combustion engine, the proportion of nitrogen monoxide with respect to the total nitrogen oxides is 60 to 95% by volume.

The method of selective catalytic reduction (SCR) has already been long known for the reduction of nitrogen oxides in oxidizing exhaust gases. In that case, ammonia as a reducing agent is metered to the exhaust gas, and that gas mixture is then conducted through a catalytic converter for selective catalytic reduction (SCR catalytic converter). At the SCR catalytic converter, the nitrogen oxides are converted selectively with ammonia to form nitrogen and water. That method is nowadays used industrially in the purification of power plant exhaust gases.

The SCR processing of the nitrogen oxides often takes place in at least two stages, with ammonia being formed in a first step from an ammonia precursor. The ammonia precursor can, for example, take place through the use of hydrolysis of urea (CO(NH₂)₂) as an ammonia precursor with water (H₂O) to form ammonia (NH₃) and carbon dioxide (CO₂). Alternatively or in addition, thermolysis of an ammonia precursor can also take place. In a second step, the actual selective catalytic reduction then takes place, for example the conversion of nitrogen monoxide (NO) and nitrogen dioxide (NO₂) with amonia (NH₃) to form nitrogen (N₂) and water (H₂O). Alternative ammonia precursors are, for example, cyanuric acid and ammonium carbamate.

Due to the necessity of adding a reducing agent to the exhaust gas, the SCR method is relatively complex for use in mobile applications. NOₓ storage technology has therefore been developed as an alternative to the SCR method. In that case, the nitrogen oxides which are contained in the exhaust gas are buffered on a nitrogen oxide storage catalytic converter in the form of nitrates. After the depletion of the storage capacity of the storage catalytic converter, the latter must be regenerated. For that purpose, the internal combustion engine is briefly operated with a rich air/fuel mixture, that is to say the air/fuel mixture is supplied with more fuel than can be completely burned with the combustion air. The unburned hydrocarbons still contained in the exhaust gas have the result that the stored nitrates are broken down to form nitrogen oxides and are converted with the hydrocarbons as a reducing agent to form nitrogen and water.

With regard to the SCR method, it is to be noted that ammonia is poisonous and is therefore subject to strict safety regulations during handling. For that reasons, it has also already been proposed to provide the reducing agent in the form of substances which release ammonia. In that case, one possibility is the provision of urea (CO(NH₂)₂) which, under suitable ambient conditions, is broken down to form ammonia and carbon dioxide. A breakdown of urea takes place, in particular, at high temperatures.

Furthermore, it is also known for the reducing agent to be stored or supplied to the exhaust gas as a solid. In that case, however, there is the problem that the dosing of the reducing agent is dependent on the provided size of the reducing agent or on the capabilities of a crushing mechanism. This makes even a supply of reducing agent on the scale of the magnitude required for the reduction of the nitrogen oxides technically difficult and complex.

In addition, the components for selective catalytic reaction in the exhaust gas system of mobile internal combustion engines are formed at least partially with porous wall structures which absorb the supplied reducing agent in virtually arbitrary and uncontrollable quantities. This has the result that an excessively high reducing agent consumption can often be observed.

### BRIEF SUMMARY OF THE INVENTION

It is accordingly an object of the invention to provide a method and a device for the dosed provision of a reducing agent, especially a solid reducing agent, for exhaust gas systems, which overcome and at least partially alleviate the hereinafore-mentioned disadvantages and technical problems of the heretofore-known methods and devices of this general type. It is intended, in particular, to propose a device for exhaust gas aftertreatment for effectively carrying out a selective catalytic reduction, in which a low consumption of reducing agent is made possible. It is also intended to specify methods which, taking into consideration the operating mode of an internal combustion engine, ensure as precise as possible a provision of reducing agent in the exhaust gas system in order to satisfy the stoichiometric demand. As low a reducing agent consumption as possible should also be sought in this case.

With the foregoing and other objects in view there is provided, in accordance with the invention, a device for exhaust gas treatment. The device comprises an exhaust gas line through which an exhaust gas can flow in a flow direction, a supply for feeding a reducing agent into the exhaust gas line, a regulating unit for dosing the reducing agent to be supplied, and a carrier body for bringing about a chemical reaction of the reducing agent with at least one constituent or component of the exhaust gas. The carrier body is positioned downstream of the supply in the flow direction, and the carrier body has at least one metallic base body at least partially including a coating with a storage capability for the reducing agent.

The exhaust gas line conventionally leads the exhaust gas, which is to be purified, from an internal combustion engine into the environment. The exhaust gas line can have a single-strand or multi-strand construction. It is also possible for the exhaust gas line to be constructed with a branch, diversion or bypass through which only a part of the exhaust gas which is generated by the internal combustion engine flows. That part of the exhaust gas can be supplied back to a main exhaust gas line.

With regard to the supply for a reducing agent, it is to be noted that it is to be selected by taking into consideration the state of aggregation of the reducing agent in which the reducing agent is to be introduced into the exhaust gas line. In this case, for example, nozzles, tube pieces or similar, preferably re-closable supply systems are used.

The regulating unit conventionally has several functions. On one hand, it can be used for dosing, that is to say quantitatively determining the reducing agent which is to be supplied. It is, however, also possible for the regulating unit, for example, to vary the frequency with which the reducing agent is to be supplied. In addition, the regulating unit can be constructed with mechanical components for closing or opening the supply. The regulating unit can also include computer programs or computer systems which influence the dosing as a function of operating parameters of the internal combustion engine, of an engine controller or else sensors which deliver, for example, information regarding the exhaust gas.

A carrier body refers, in particular, to a honeycomb body. The latter has a plurality of channels which are disposed substantially parallel to one another and which are formed in such a way that the exhaust gas can flow through them in the flow direction. The channels are preferably not completely closed off. The carrier body is constructed with a large surface and serves as a type of reaction space for the exhaust gas and the reducing agent. The chemical reaction of the reducing agent with at least one constituent or component of the exhaust gas is brought about there with, in particular, a selective catalytic reduction of nitrogen oxides being meant in this case. In addition to that function, it is however also possible for at least one further chemical reaction to take place there, in particular if the reducing agent is not suitable for selective catalytic reduction of nitrogen oxides.

It is now proposed herein that the carrier body be constructed with at least one metallic base body which is provided with a defined coating. In this case, the coating is selected in such a way that a limited, relatively small storage capacity for the reducing agent is provided. A move is therefore made away from known systems which include carrier bodies that are composed (only) of open-pored material, specifically in particular of a material which is suitable for selective catalytic reduction. Open-pored constructions of that type offer the supplied reducing agent such a large storage capacity that the latter is filled uncontrollably and accordingly, specifically with regard to the regulation of a reducing agent supply of that type, permits no reliable information with regard to the reducing agent available in the exhaust gas system. A certain storage capacity is, however, necessary since, if appropriate, the reducing agent is metered in a dosed fashion, that is to say there are repeated concentration peaks in the exhaust gas. In order to “smooth” those concentration peaks in the exhaust gas system, the metallic base body has a coating with a storage capacity for the reducing agent. A device of that type permits particularly targeted, precise regulation or dosing of the reducing agent, so that the reducing agent consumption can be kept very low during the operation of an exhaust gas system of that type. It is pointed out herein in addition that, with regard to the material of the base body, use is preferably made of high-temperature-resistant and corrosion-resistant metal sheets which, in addition to iron, preferably have high proportions of chrome or nickel.

In accordance with another feature of the invention, the coating includes at least one of the following components: titanium dioxide (TiO₂), tungsten trioxide (WO₃), molybdenum trioxide (MoO₃), vanadium pentoxide (V₂O₅), silicone dioxide (SiO₂), sulfur trioxide (SO₃), zeolite. With regard to zeolite, it is to be noted that it is possible in this case to resort, in particular, to acid-resistant zeolites which have been exchanged with transition metals, such as for example dealuminized Y-zeolite, mordenite, silicate or ZSM-5. The operating temperature of the catalytic converters is approximately in the range of from 300° C. to 500° C. The constituents of the coating specified herein promote, individually and/or in combination with one another, in particular the selective catalytic reaction of a reducing agent (for example urea, ammonia) with a constituent of the exhaust gas (for example nitrogen oxides).

In accordance with a further feature of the invention, it is particularly advantageous for the coating to have a thickness in a range of from 0.01 to 0.03 mm. The range specified herein ensures, on one hand, that the intermittent, dosed addition of the reducing agent can be compensated to a certain degree, so that sufficient reducing agent is present for a conversion of the nitrogen oxides. On the other hand, it is however also ensured that a reserve of reducing agent does not exceed a certain limit value, so that precise regulation of the dosing of the reducing agent which is to be supplied is possible. The thickness is to be selected, in particular, by taking into consideration the internal combustion engine, since the latter also determines the composition of the exhaust gas and therefore the proportion of the nitrogen oxides which are to be converted. With regard to a diesel engine, it is therefore particularly preferable for the latter to have a quantity of coating which is adapted to the displacement or adapted to the power. It is thus proposed, in particular, that the quantity of coating be in a range of from 100 to 250 grams of coating per liter of displacement of the internal combustion engine, preferably in a range of from 150 to 200 g of coating per liter of displacement.

In accordance with an added feature of the invention, the base body is permeable to gas. In other words, this means that the base body itself is not a storage device for a constituent of the exhaust gas or of the reducing agent. This does not mean that the base body cannot be constructed with channels, or passages which connect the channels, through which an exhaust gas can flow, but rather that a porous or open-pored material state of the base body is to be foreseen.

In accordance with an additional feature of the invention, it is particularly advantageous for a device for determining the quantity of nitrogen oxide available in the region of the carrier body to be provided. Sensors and/or probes are particularly suitable in this case. These can give information regarding the nitrogen oxides carried by the exhaust gas and/or the nitrogen oxides adhered to and/or embedded in the region of the carrier body. Proceeding from that information, it is possible to carry out calculations as to what demand there is for reducing agent, or how much of the buffered reducing agent in the coating is now consumed.

In accordance with yet another feature of the invention, it is additionally advantageous for a catalytic converter element to be disposed downstream of the carrier body in the flow direction. The catalytic converter element has a coating including platinum. The coating serves, in particular, to eliminate “excess” reducing agent which is still carried by the exhaust gas due to a low demand in the region of the carrier body and/or due to the limited storage capacity of the carrier body. When the reducing agent comes into contact with the catalytic converter element or the catalytically active platinum, the reducing agent is converted into other substances which can, if appropriate, be further converted in subsequent exhaust gas treatment units. In light of the fact that particularly precise dosing is made possible with the method described herein, a catalytic converter element can be constructed to have a very small volume, since the quantities of excess supplied reducing agent are very low.

In accordance with yet a further feature of the invention, a tank and a delivery device for the reducing agent as a solid are provided. Those components are preferably suitable for storing and transporting solid urea.

The tank can, for example with regard to a passenger vehicle, be provided in a depression of the luggage compartment, for example where the spare wheel is nowadays mounted. Since solid urea is relatively sensitive to pressure and it should be possible to extract portions from the tank in as simple a manner as possible, the filling level of the tank is preferably to be selected in a range of from 100 to 500 mm. In this case, a substantially silo-like construction with an outlet cone can be advantageous. Furthermore, it is also possible for the tank, in addition to a feed line to the regulating unit, to also be formed with a return line from the regulating unit to the tank in order to re-supply excess reducing agent, or reducing agent which is still in the feed line and has not been required for a relatively long period of time. It is preferable for a total pressure in the tank of less than 1 Pascal (1 Pascal corresponds to 10⁻⁵ bar) or a water partial pressure of less than 0.1 Pascal to be permanently ensured. In order to prevent the solid reducing agent from being broken down by friction against the inner wall of the tank as a result of the movement or vibration which occur as the passenger vehicle is traveling, the tank is preferably provided with an inner coating which is smooth and therefore, due to its low friction, permits easy sliding of the solid urea portions. With regard to use in a passenger vehicle, a tank volume is to be provided which has a filling that is sufficient for operation of at least 30,000 km, wherein the filling level can be checked through the use of a suitable display or filling level inspection. With respect to the safety regulations regarding urea and ammonia, the tank is to have an impermeable construction, which advantageously also makes it possible for the present filling of the tank to be calculated as well.

The delivery device can fundamentally be a mechanical, electromechanical or pneumatic device or a combination thereof. A delivery rate should preferably be between 0.1 and 3 kg of reducing agent per hour. In this case, solid bodies with a diameter in a range of from 1 to 5 mm should be transportable. During the delivery, it is to be ensured that the portions of the reducing agent are not destroyed or broken down. The delivery device is preferably formed with a spiral, a type of screw feeder, a transport belt, a transport chain or a compressed air system, which is preferably maintenance-free.

The delivery device additionally includes a delivery line which can, if appropriate, be composed of a feed line and/or a return line. In light of the fact that a solid reducing agent rapidly loses its solid state of aggregation conventionally under normal ambient conditions and passes into a gaseous state, thermally insulated delivery lines are preferred. The inner diameter of a delivery line of that type should be in a range of from 1 to 10 mm, wherein in the case of a non-rectilinear profile of the delivery line, a bend radius of 5 to 100 mm should not be respectively undershot or exceeded. It is also advantageous in this case to provide a friction-minimizing coating in the inner region of the delivery line. In light of the above-described position of the tank, the delivery line can cover a distance of 3 to 4 meters before the reducing agent reaches the regulating device. In this case, one or more portions of the reducing agent can be delivered simultaneously, and preferably with a frequency of a maximum of 100 portions per second. Specifically with regard to long standstill times, it is advantageous that a device for emptying the delivery line is provided.

In accordance with yet an added feature of the invention, a device is provided for checking the dosing of the reducing agent. This means, for example, that it is fundamentally possible to carry out the physical dosing even in the region of a transition from a tank to a delivery device or into the delivery device itself with, for example, the regulating unit then including a device for checking the dosing. In this case, it is again possible for various sensors as well as specially-shaped portioning volumes which are adapted to the demanded dosing to be provided.

In accordance with yet an additional feature of the invention, a distributor which is disposed upstream of the carrier body in the flow direction is provided. The distributor, which is disposed downstream of the infeed, has the function of distributing the supplied dose of reducing agent uniformly in the exhaust gas flow. In addition, the distributor can also be provided with a catalytic function. For example, hydrolysis of the supplied urea can take place there in such a way that ammonia is formed. In addition to a hydrolysis coating, the distributor can also be provided with a specially-structured surface which, during the impact of the solid reducing agent, ensures a breakdown into a plurality of particles. In addition, openings can be provided which, on one hand, permit a uniform distribution of the reducing agent over the cross section of the exhaust gas line and, on the other hand, reduce the flow resistance for the exhaust gas. A distributor of that type can be provided as a honeycomb structure, as a perforated plate, as a sieve, as a grate or in some similar way. Under some circumstances, it is advantageous to construct the distributor in such a way that it can be heated, in particular electrically.

One particularly preferred embodiment variant of the distributor is described below:

The distributor is constructed as an impact surface with a plurality of openings. The width of the openings is in a range of from 0.5 to 1 mm and is therefore at least twice as small as the diameter of a solid body of the reducing agent, which is formed so as to be spherical. The impact surface is constructed with a surface which has peaks that have a mean height in a range of from 0.2 to 1 mm. The distributor is constructed in such a way that it can be electrically heated, wherein the temperature of the distributor can be varied. For this purpose, it is advantageous for the distributor to have a plurality of layers which can be heated separately and if appropriate with different levels of heating power.

The device according to the invention is preferably part of an automobile, in particular of a passenger or utility vehicle having a diesel engine as an internal combustion engine. The device according to the invention can also be formed in an exhaust strand or tract of a stationary internal combustion engine, for example of a power plant.

With the objects of the invention in view, there is also provided a method for the treatment of an exhaust gas in an exhaust gas line of an internal combustion engine. The method comprises at least a) determining a quantity of nitrogen oxide in the exhaust gas, b) determining a dose of a reducing agent to be supplied to the exhaust gas line, taking into consideration a reserve of reducing agent stored in the exhaust gas line, and c) supplying the dose of the reducing agent.

A device as described above is particularly suitable for carrying out the method.

The determination of the quantity of nitrogen oxide in the exhaust gas according to step a) can take place by calculation or through the use of measured value acquisition. A calculation can, for example, take place on the basis of the operating mode of the internal combustion engine with the aid of an engine controller and stored empirical values with regard to the nitrogen oxide production. Alternatively or in addition, it is also possible to determine the nitrogen oxide content of the exhaust gas through the use of exhaust gas sensors.

In step b), the dose of the reducing agent which is to be supplied is variably determined by taking into consideration a stored reserve of reducing agent. In this case, in particular the reducing agent reserve stored in the coating provided for selective catalytic reaction is taken into consideration. If, for example as a result of the determined nitrogen oxide content in the exhaust gas, a physical demand for complete conversion of the nitrogen oxides is calculated, then substantially only that proportion of reducing agent which is still required beyond the reserve of reducing agent is provided as a dose and supplied. The reducing agent consumption can thereby be considerably reduced.

In accordance with another mode of the invention, advantageously, at least step c) is carried out in a discontinuous fashion. This means that an intermittent addition of reducing agent takes place at constant or variable time intervals. The frequency with which reducing agent is supplied with a predefined dose is dependent substantially on the operation of the internal combustion engine and on the available portions of the reducing agent. If, for example, solid bodies of reducing agent are supplied which have a diameter in the region of 2 to 3 mm, then it is possible to realize a frequency in a range of from approximately 130 to 140 Hz at full load of the internal combustion engine and in the range below 50 Hz at idle. With particularly precise regulation of the dosing, however, it is possible to realize considerably lower frequencies, in particular below 10 Hertz, which results in a considerable reduction in technical expenditure.

In accordance with another mode of the invention, at least step c) is carried out only when the quantity of nitrogen oxide determined in step a) exceeds a minimum value. Furthermore, it is also advantageous for at least step c) to be carried out only when the internal combustion engine is operating under load. It is therefore taken into consideration that the exhaust gas system and, in particular, the above-described carrier body has a certain storage capacity for the reducing agent. If the nitrogen oxide quantity is very low, the reducing agent reserve can initially be consumed. The same applies as long as the internal combustion engine is, for example, at idle or in the overrun or overdrive mode. In addition to step c), step b) can also be suspended for those time periods.

With the objects of the invention in view, there is furthermore provided a method for the treatment of an exhaust gas in an exhaust gas line of an internal combustion engine. The method comprises at least x) providing a constant dose of a reducing agent to be supplied to the exhaust gas line, y) determining a reserve of reducing agent stored in the exhaust gas line, and z) supplying the dose of the reducing agent if the reserve falls below a limit value.

The device described according to the invention can also advantageously be used for carrying out this method. In this method, only a constant dose of reducing agent is supplied, for example because the reducing agent is available in predefined portions of uniform size. In this case, it is proposed herein according to the invention that the reserve of reducing agent which is stored in the exhaust gas line or in the carrier body also be taken into consideration in the supply. A very reducing-agent-saving operating mode is therefore again possible.

In this case, too, at least step z) and if appropriate also step y) can be suspended as long as a certain quantity of nitrogen oxide in the exhaust gas has not reached a minimum value or the internal combustion engine is not operating under load.

In accordance with another mode of the invention, the limit value is advantageously determined as a function of at least one of the following parameters:
the quantity of nitrogen oxide which is present in the exhaust gas,
the operating state of the internal combustion engine,
the temperature of the exhaust gas, and
the quantity of oxygen which is present in the exhaust gas.

In accordance with a concomitant mode of the invention, with regard to the two methods according to the invention, it is proposed that the reducing agent be provided as solid bodies of equal dose. In this case, solid bodies substantially in the form of a ball, which include urea, are preferably provided. The urea is preferably provided with a hydrophobic outer skin, with diameters in a range of from 2 to 3 mm being preferable. The thickness of the hydrophobic outer skin is advantageously in a range of from 2 to 30 μm. The outer skin can also be formed by a plurality of layers. The outer skin, or at least one of its layers, includes in particular, formaldehyde or a long-chain hydrocarbon, for example dodecane, or else waxes such as, for example, paraffin. The outer skin can include a signal color for denoting the substance of content. Specifically with regard to the supply of the solid bodies with an outer skin which is relatively strong for storage and transport, it is advantageous to provide the outer skin with at least one predetermined breaking point such that the solid body is broken down more easily into a plurality of particles when it impacts against a distributor. The predetermined breaking point can be formed as a reduced outer skin thickness or as a depression and can extend into at least one layer of the outer skin. Under some circumstances, it is also advantageous to provide a plurality of microcapsules in an outer skin of the solid body, which in turn has a positive effect with regard to the distribution in the exhaust gas flow when the outer skin breaks.

The methods specified above are also preferably suitable for operating an exhaust gas system of an automobile, in particular of a diesel-engine-driven passenger or utility vehicle, or a corresponding stationary internal combustion engine.

Other features which are considered as characteristic for the invention are set forth in the appended claims. It is noted that the features listed individually in the claims can be combined with one another in any desired technologically meaningful way and lead to further embodiments of the invention. It is also possible, in a complementary manner, to employ features and parameters described in more detail in the description.

Although the invention is illustrated and described herein as embodied in a method and a device for the dosed provision of a reducing agent, especially a solid reducing agent, for exhaust gas systems, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE SEVERAL VIEWS OF THE DRAWING

FIG. 1 is a block diagram showing the construction of a first embodiment variant of the device according to the invention;

FIG. 2 is a block diagram showing the construction of a second embodiment variant of the device according to the invention;

FIG. 3 is an enlarged, diagrammatic, elevational view showing the region of an exhaust gas line with a reducing agent supply;

FIG. 4 is a partly broken-away, elevational view of an embodiment variant of a carrier body for a selective catalytic reaction;

FIG. 5 is a diagram illustrating the load and exhaust gas behavior of an internal combustion engine; and

FIG. 6 is a diagram illustrating the profile of a reducing agent supply according to one embodiment of the method of the invention.

### DETAILED DESCRIPTION OF THE INVENTION

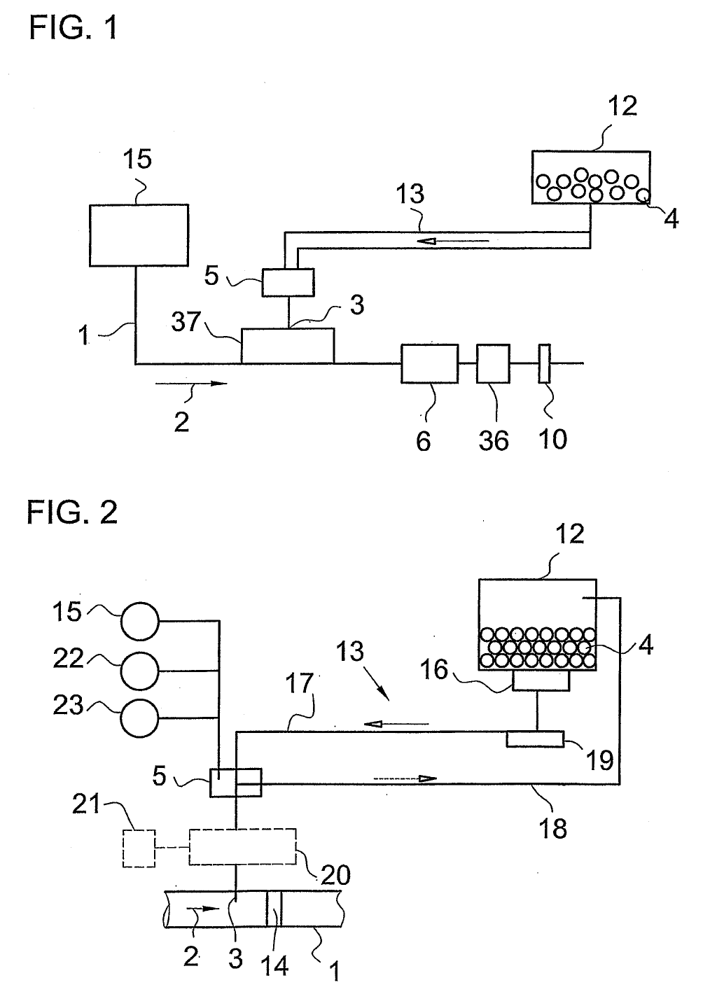

Referring now to the figures of the drawings in detail and first, particularly, to FIG. 1 thereof, there is seen a diagrammatic illustration of the construction of a device for exhaust gas aftertreatment, in particular of a diesel-engine driven motor vehicle. The exhaust gas generated by an internal combustion engine 15 flows through an exhaust gas line 1 in a flow direction 2. The exhaust gas line 1 illustrated herein has a branch 37, through the use of which a part of the exhaust gas that is produced is conducted past a supply 3 for a reducing agent 4 before finally opening out again into the single-strand exhaust gas line 1. The reducing agent 4 is stored in a tank 12 and is conducted through the use of a delivery device 13 to the supply 3. A regulating unit 5 is provided in order to regulate the desired dosing of the reducing agent 4 which is to be supplied. The reducing agent 4 is admixed to the exhaust gas through the supply 3 and subsequently flows to a carrier body 6 which is positioned downstream of the supply 4 in the flow direction 2. The carrier body 6 has a device for bringing about a selective catalytic reduction of nitrogen oxides. A further exhaust gas treatment component 36 is disposed downstream of the carrier body 6, as viewed in the flow direction. The use of such an exhaust gas treatment component 36 in the illustrated position is only one example of many others. For example, catalytic converters, mixing elements, filters, particle traps, absorbers etc. can be considered as an exhaust gas aftertreatment component 36. Finally, a catalytic converter element 10, which is also provided in the exhaust gas line 1, for example converts residues of the reducing agent 4 which are present in the exhaust gas.

FIG. 2 shows a further embodiment of the device, with the region of the reducing agent supply being singled out herein in particular. The reducing agent 4, which is present as substantially spherical solid bodies, is stored in the tank 12. An outlet of the reducing agent 4, which is preferably urea, is provided as a re-closable valve 16. It is possible to use slides or similar components as the valve 16, which can alternate on demand at least into an open and a closed position. The delivery device 13 is provided herein through the use of a drive 19 which ensures the transport of the reducing agent at least through a feed line 17 to the regulating unit 5. Mechanical or pneumatic systems, in particular, are considered for the drive. Pneumatic systems have the advantage that they permit the transport of individual reducing agent solid bodies, so that the feed line 17 can be kept substantially empty. However, for the case in which, for example, mechanical or electromechanical systems are used, it is also possible for the entire feed line to be filled with reducing agent 4 at least at times. In such a case, it is advantageous if, after a physical dosing of the reducing agent 4 through the regulating unit 5, at least a part of the reducing agent 4 which is situated in the feed line 17 is returned again to the tank 12 through a return line 18. This should be carried out, in particular, when ambient conditions which adversely affect the durability of the reducing agent as solid bodies prevail in the feed line 17 and/or in the return line 18.

The dosing of the reducing agent 4 by the regulating unit 5 can be carried out by the method according to the invention. In this case, the regulating unit 5 can, for example, use information regarding the internal combustion engine 15 from data of an engine controller 22 or measured values from sensors 23.

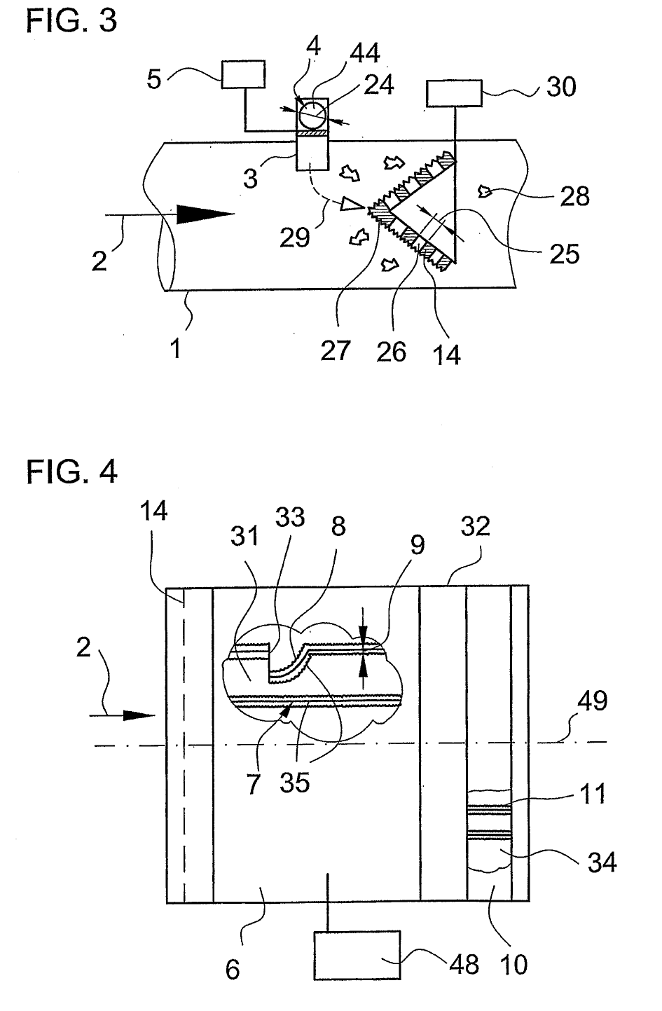

Proceeding from the regulating unit 5, the reducing agent 4 is moved onward to the supply 3, with the reducing agent 4 being entrained by the exhaust gas quantity which flows in the flow direction 2, and being thrown onto a distributor 14 as shown, as it exits the supply 3 and enters into the exhaust gas line 1. In this case, the reducing agent 4 is preferably introduced into the exhaust gas line as solid bodies, although it is also possible (as indicated in FIG. 3 by a flight path or trajectory 29 shown in broken lines) for the reducing agent to be previously converted in a reactor into another state of aggregation (liquid and/or gaseous), for example through the use of sublimation or melting or by dissolving in a solvent, in particular in water or in a hydrocarbon. In the reactor 20, which is preferably provided with a first heating device 21, a breakdown of urea into ammonia, for example, takes place. The ammonia is then supplied as a reducing agent to the exhaust gas line 1.

FIG. 3 again shows the supply of the reducing agent 4. The reducing agent 4 is present with a constant dose 44 and a mean diameter 24 of approximately 2 to 2.5 mm, and is passed into the exhaust gas line 1 through the use of the regulating unit 5 and the supply 3. As it enters into the exhaust gas line 1, the reducing agent 4 is taken up by the exhaust gas flow, which moves in the flow direction 2, and is thrown against the distributor 14, with the reducing agent 4 being broken down into a multiplicity of particles 28. The particles 28 are dissolved as a result of the conditions, in particular the exhaust gas temperature, which prevail in the exhaust gas line 1.

In the illustrated embodiment variant, the distributor 14 is shown in the form of a funnel, although this is not strictly necessary. The distributor 14 has a sharp-edged structured surface 27 which is advantageously provided with a non-illustrated coating for the hydrolysis of the supplied urea. In addition, the distributor 14 has a plurality of openings 26 with a mean width 25 in a range of from 0.5 to 1 mm. The distributor 14 can be electrically heated and for this purpose is formed with a second heating device 30.

FIG. 4 shows one embodiment variant of a particularly compact SCR unit. In this case, a distributor 14, which is embodied as a sieve, a carrier body 6 and a catalytic converter element 10 are disposed in series in the flow direction in a common housing 32. The carrier body 6 has a metallic base body 7 which is formed with a coating 8 having a storage capacity for the reducing agent. In this case, the metallic base body 7 is illustrated as a honeycomb body which includes at least partially structured metal foils 35. In this case, at least one smooth and one corrugated metal foil 35 are preferably twisted or wound with one another in such a way that channels 31 are formed through which the exhaust gas can flow in the direction of an axis 49. The channels or passages 31 are accordingly delimited by the metal foils 35 and the metal foils 35 are coated with the coating 8, of a predefined thickness 9, which promotes or catalyzes the selective catalytic reaction. Openings or feedthroughs 33, which are provided for the exchange of exhaust gas into adjacent channels 31, are formed by impressions, breaks, indentations or punched-out portions in the metal foils 35.

The catalytic converter element 10 has a plurality of flow paths 34 which preferably extend substantially parallel to the axis 49. The catalytic converter element 10 is preferably also embodied as a metallic honeycomb body. The flow paths 34 are provided with a layer 11 or coating 8, in particular a ceramic coating composed, for example, of washcoat, in or on which platinum or another high-grade metal is disposed, in order to convert excess reducing agent 4 which in rare cases exits the carrier body 6.

The illustrated unit is also enhanced in that a plasma can be provided therein. The plasma further promotes the conversion of the nitrogen oxides, in particular. The unit is connected to a voltage source 48 in order to form the plasma.

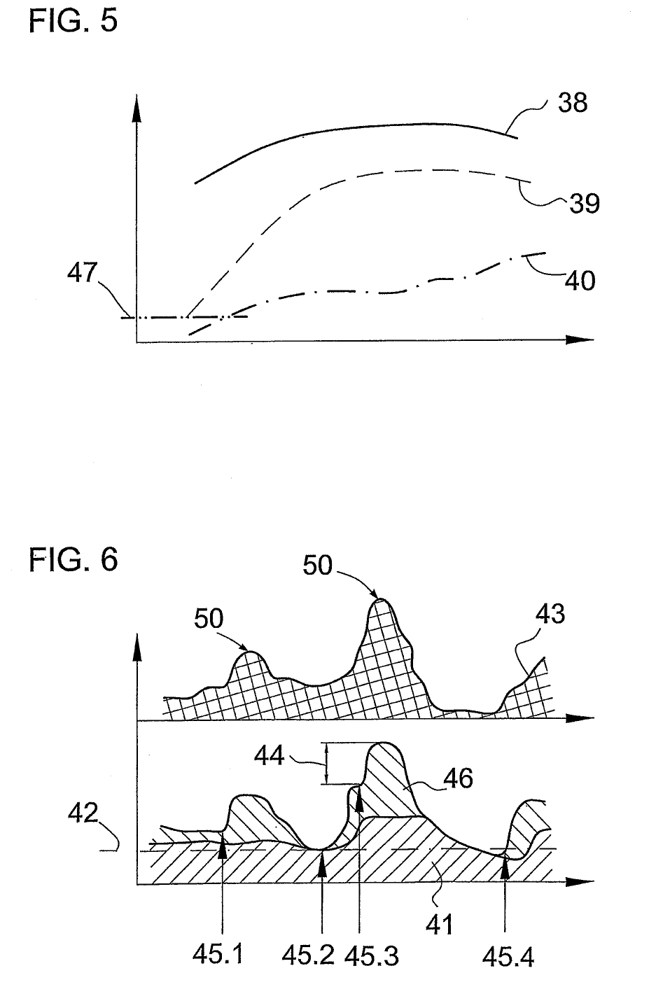

FIG. 5 illustrates, for example, a characteristic diagram of a passenger vehicle having a diesel engine with a displacement or capacity of 3 liters. In this case, a power or performance profile 38, an exhaust gas mass flow rate profile 39 and a nitrogen oxide emission profile 40, are plotted against the speed of the engine (abscissa). In this case, the power varies according to the power profile 38, for example from 20 kW to 120 kW. In the case of such a power profile 38, approximately the exhaust gas mass flow rate profile 39 which is denoted by a dashed line, is generated by the engine. The nitrogen oxide emission profile 40, illustrated at the bottom, shows the proportion of the exhaust gas mass flow rate which is to be converted through the use of the selective catalytic reaction at the present power in each case. For illustration, a minimum value 47 is also indicated which is observed, if appropriate, in the method according to the invention. In the characteristic diagram described herein, the required quantities of reducing agent are in a range of from 0.014 to 0.144 kg/h, with an elimination of the entire nitrogen oxide being assumed (100% conversion rate).

FIG. 6 is intended to diagrammatically illustrate, on one hand, the demand for reducing agent for as complete a conversion of the nitrogen oxides as possible, and on the other hand the actual provision of reducing agent according to the described method of the invention. In the upper part of the diagram, a reducing agent demand 43, which results from the characteristic diagram of the internal combustion engine, is illustrated by way of example. Illustrated below is the actual provision of reducing agent, with a distinction being made between the reducing agent provided in the exhaust gas (denoted as an addition 46) and reducing agent stored in the exhaust gas line (denoted herein as a reserve 41).

A first peak 50 of the reducing agent demand 43 is illustrated at the left in the figure. According to the method of the invention, it has been detected that, for example, a high quantity of nitrogen oxides is present in the exhaust gas, so that at a first time 45.1, there is insufficient reducing agent available, so that dosing of reducing agent is required at that time 45.1, which can be seen from the steep rise of the graph of the addition 46. As a result of the intensified selective catalytic reaction and the high nitrogen oxide proportion in the exhaust gas, the available quantity of the provided reducing agent decreases, as can be seen from the illustration adjacent the time 45.1 on the right. Since new reducing agent is no longer being supplied, that quantity decreases further, so that finally the reserve 41 also decreases. At a time 45.2, the reserve 41 of reducing agent reaches a limit value 42, so that now a further dosing of reducing agent takes place according to the invention. Shortly thereafter, it is detected that a second peak 50 of the reducing agent demand 43 is present, so that a renewed reducing agent supply is carried out at a time 45.3. It can be seen from the lower illustration that approximately the same dose 44 of reducing agent has been added at the dosing times 45.1, 45.2 and 45.3, and therefore a method is described herein in which the reducing agent has been supplied as solid bodies of equal dose. After the second peak 50, there is a time span in which there is approximately no demand for reducing agent, with the internal combustion engine being, for example, at idle or in an overrun or overdrive mode. Due to the low quantity of nitrogen oxides in the exhaust gas, the addition 46 and the reserve 41 decrease relatively slowly. Finally, however, the limit value 42 of the reserve 41 is reached again, so that a renewed reducing agent supply takes place at a time 45.4.

The method according to the invention described herein and the device according to the invention which is particularly suitable for carrying out the method described according to the invention is economical with reducing agent, wherein nevertheless an approximately 100% conversion of nitrogen oxides which are contained in the exhaust gas can be ensured.

1. A device for exhaust gas treatment, the device comprising:
an exhaust gas line through which an exhaust gas can flow in a flow direction;
a supply for feeding a reducing agent into said exhaust gas line;
a regulating unit for dosing the reducing agent to be supplied; and
a carrier body for bringing about a chemical reaction of the reducing agent with at least one constituent of the exhaust gas, said carrier body being positioned downstream of said supply in said flow direction, and said carrier body having at least one metallic base body at least partially including a coating with a storage capability for the reducing agent.

2. The device according to claim 1, wherein said coating includes at least one component selected from the group consisting of titanium dioxide, tungsten trioxide, molybdenum trioxide, vanadium pentoxide, silicone dioxide, sulfur trioxide, and zeolite.

3. The device according to claim 1, wherein said coating has a thickness in a range of from 0.01 to 0.03 mm.

4. The device according to claim 1, wherein said base body is permeable to gas.

5. The device according to claim 1, which further comprises a device for determining a quantity of nitrogen oxide available in vicinity of said carrier body.

6. The device according to claim 1, which further comprises a catalytic converter element disposed downstream of said carrier body in said flow direction, said catalytic converter element having a coating including platinum.

7. The device according to claim 1, which further comprises a tank and a delivery device for the reducing agent in solid form.

8. The device according to claim 1, which further comprises a device for checking dosing of the reducing agent.

9. The device according to claim 1, which further comprises a distributor disposed upstream of said carrier body in said flow direction.

10. A method for the treatment of an exhaust gas in an exhaust gas line of an internal combustion engine, the method comprising the following steps:
a) determining a quantity of nitrogen oxide in the exhaust gas;
b) determining a dose of a reducing agent to be supplied to the exhaust gas line, taking into consideration a reserve of reducing agent stored in the exhaust gas line; and
c) supplying the dose of the reducing agent.

11. The method according to claim 10, which further comprises carrying out at least step c) in a discontinuous fashion.

12. The method according to claim 10, which further comprises carrying out at least step c) only when the quantity of nitrogen oxide determined in step a) exceeds a minimum value.

13. The method according to claim 10, which further comprises carrying out at least step c) only when the internal combustion engine is operating under load.

14. A method for the treatment of an exhaust gas in an exhaust gas line of an internal combustion engine, the method comprising the following steps:
x) providing a constant dose of a reducing agent to be supplied to the exhaust gas line;
y) determining a reserve of reducing agent stored in the exhaust gas line; and
z) supplying the dose of the reducing agent if the reserve falls below a limit value.

15. The method according to claim 14, which further comprises determining the limit value as a function of at least one of the following parameters:
a quantity of nitrogen oxide present in the exhaust gas;
an operating state of the internal combustion engine;
a temperature of the exhaust gas; and
a quantity of oxygen present in the exhaust gas.

16. The method according to claim 10, which further comprises providing the reducing agent as solid bodies of equal dose.

17. The method according to claim 14, which further comprises providing the reducing agent as solid bodies of equal dose.
